(19) United States
(12) Patent Application Publication
(10) Pub. No.: US 2016/0338341 A1
(43) Pub. Date: Nov. 24, 2016

(54) SEAT ADJUSTING TREE STAND

(71) Applicant: Aaron Rene Thevenet, Breaux Bridge, LA (US)

(72) Inventor: Aaron Rene Thevenet, Breaux Bridge, LA (US)

(21) Appl. No.: 14/923,832

(22) Filed: Oct. 27, 2015

Related U.S. Application Data
(60) Provisional application No. 62/165,592, filed on May 22, 2015.

(51) Int. Cl. A01M 31/02

(52) U.S. Cl. CPC A01M 31/02

(57) ABSTRACT

An adjustable tree stand is provided. The tree stand includes a seat post having a bottom end and a top end, a substantially hollow outer post, and an inner post disposed within the outer post. The inner post telescopes with the outer post, thereby making the height of the seat post adjustable. A seat secured at the top end of the seat post. A foot rest is secured at the bottom end of the seat post. At least one tree bracket protrudes from a rear side of the seat post. The tree bracket includes a first arm and a second arm angled away from one another and operable to receive at least a portion of a tree trunk in between. A strap may be used to secure the seat post to the tree trunk.

### CROSS-REFERENCE TO RELATED APPLICATION

This application claims the benefit of priority of U.S. provisional application No. 62/165,592, filed May 22, 2015, the contents of which are herein incorporated by reference.

### BACKGROUND OF THE INVENTION

The present invention relates to tree stands and, more particularly, to an adjustable tree stand.

Tree stands or deer stands are open or enclosed platforms used by hunters. The platforms are secured to trees in order to elevate the hunter and give him or her a better vantage point. The seat height of current tree stands is fixed and thereby does not accommodate to the different heights of hunters. Further, hunter's legs can get tired while sitting long hours in a tree, tempting the hunter to move and readjust by standing or kicking their legs. Lots of movement while hunting will likely decrease a hunter's success in finding and killing game.

As can be seen, there is a need for an adjustable tree stand allowing hunter's to stealthily readjust while in a tree.

### SUMMARY OF THE INVENTION

In one aspect of the present invention, a tree stand comprises: a seat post comprising a bottom end and a top end, a substantially hollow outer post, and an inner post disposed within the outer post; a seat secured at the top end of the seat post; a foot rest secured at the bottom end of the seat post; at least one tree bracket protruding from a rear side of the seat post and comprising a first arm and a second arm operable to receive at least a portion of a tree trunk in between; and a strap operable to secure the seat post to the tree trunk, wherein the seat post comprises a fixed position and an adjustable position, wherein the fixed position comprises the outer post and the inner post fixed relative to each other and the adjustable position comprises the outer post and the inner post slidably engaged and operable to adjust a height of the seat post.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is an exploded view of an embodiment of the present invention;

FIG. 3 is a front view of an embodiment of the present invention;

FIG. 4 is a front view of the present invention illustrating the lifting of the lever to release the piston and raise the seat;

FIG. 5 is a front view of the present invention, illustrating the folding out of the pegs; and

FIG. 6 is a side view of the present invention, illustrating the adjustment of the platform and seat.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

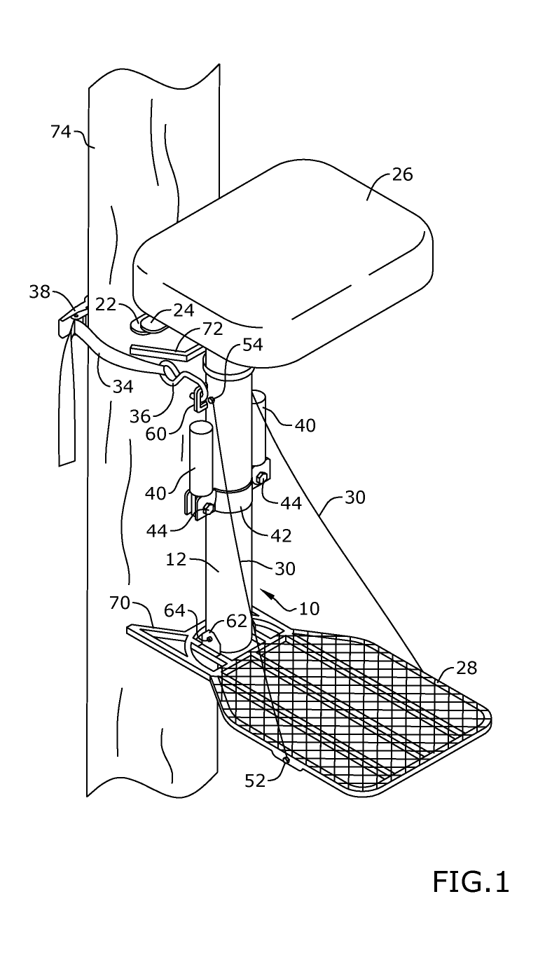

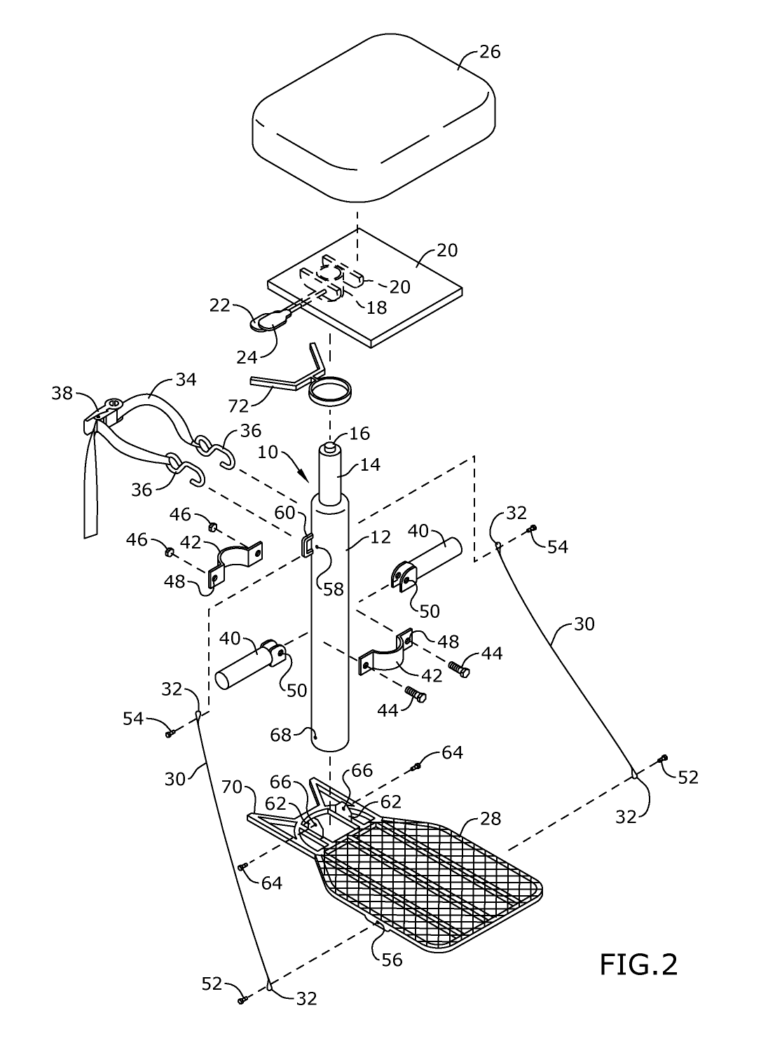

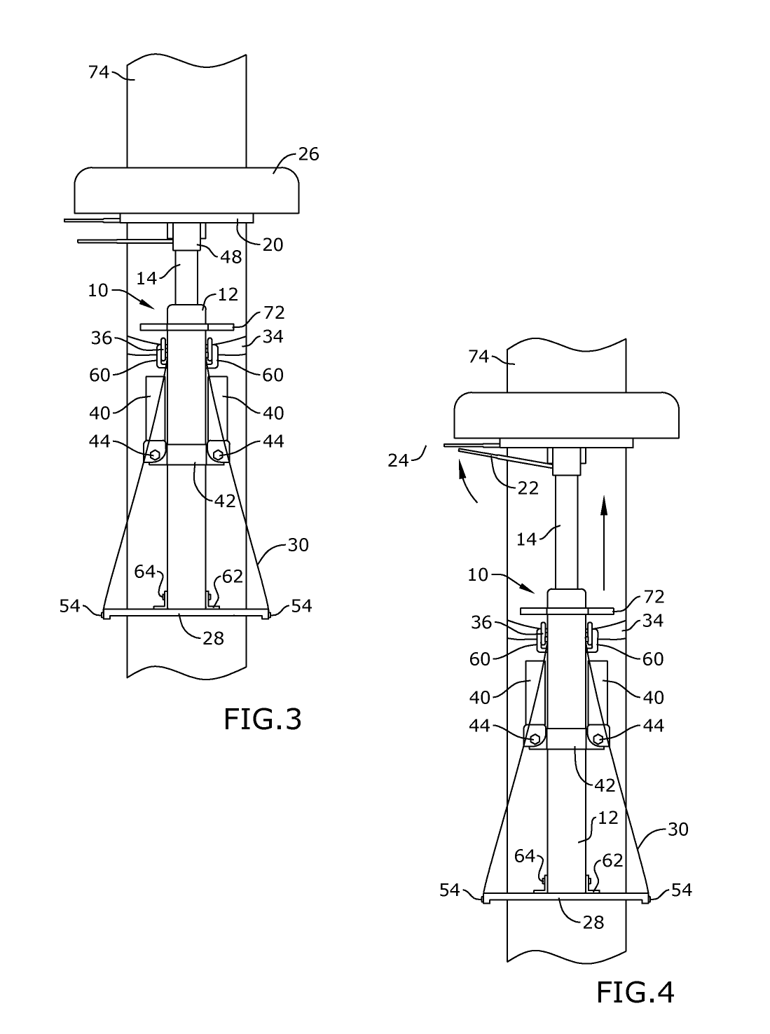

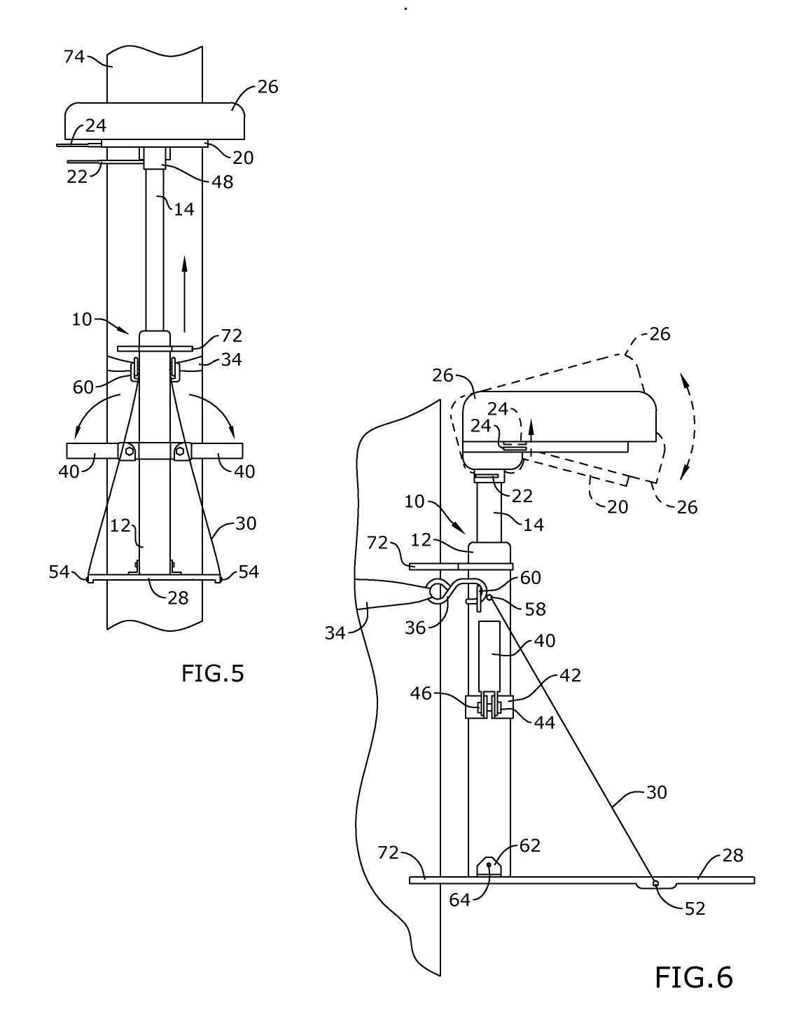

Referring to FIGS. 1 through 6, the present invention includes a tree stand. The tree stand includes a seat post 10 having a bottom end and a top end, a substantially hollow outer post, and an inner post disposed within the outer post. The inner post telescopes with the outer post, allowing the height of the seat post 10 to be adjusted. A seat 26, such as a cushioned seat, is secured to the top end of the seat post 10. A foot rest 28 is secured at the bottom end of the seat post 10. At least one tree bracket 70, 72 protrudes from a rear side of the seat post 10. The tree bracket 70, 72 includes a first arm and a second arm angled away from one another and operable to receive at least a portion of a tree trunk 74 in between. A strap 34 may be used to secure the seat post 10 to the tree trunk 74.

The seat post 10 includes a fixed position and an adjustable position. The fixed position includes the outer post and the inner post fixed relative to each other and the adjustable position includes the outer post and the inner post slidably engaged and operable to adjust a height of the seat post 10. In certain embodiments, the seat post 10 may be a gas spring including a piston 14 as the inner post and a cylinder 12 as the outer post. A height adjustment lever 22 may engage and disengage with a release button 16. When the lever engages the release button 16, the seat post 10 is transitioned to the adjustable position where the seat 26 may move up and down relative to the foot rest 28. When the lever 22 is disengaged, the seat post 10 may be fixed at the desired height.

As mentioned above, the tree stand is securable to a tree trunk 74. In certain embodiments, the length of the strap 34 is adjustable by a ratchet 38. The strap 34 is adjusted to fit around the tree trunk 74. A first strap hook 36 is attached to the first end of the strap 34 and a second strap hook 36 is attached to the second end of the strap 34. The seat post 10 may include and first and second seat post hooks 60. The strap 34 may wrap around the tree trunk 74, the first strap hook 36 may hook onto the first seat post hook 60 and the second strap hook 36 may hook onto the second seat post hook 60. The ratchet 38 may be further tightened so that the tree bracket 70, 72 is pressed up against the tree trunk 74 and the tree stand is safely secured to the tree.

The tree brackets 70, 72 may each extend from a rear side of the seat post 10 and may each include a first arm and a second arm that extend at an angle away from one another, forming a receptacle sized to receive and secure against a portion of the tree trunk 74. The tree brackets 70, 72 may include a first tree bracket 70 and a second tree bracket 72. The first tree bracket 70 may extend from a back portion of the foot rest 28. The second tree bracket 72 may include a ring sized to fit around and secure near the top end of the seat post 10. The tree brackets 70, 72 may provide a large enough space from the seat 26 and the tree trunk 74 to allow the seat 26 to freely move up and down.

The foot rest 28 of the present invention may include a substantially flat plate member secured to the bottom of the seat post 10. The foot rest 28 may extend from the front side of the seat post 10. The foot rest 28 may be substantially parallel with the seat 26, allowing a user to rest their feet. In certain embodiments, the foot rest 28 may include an aperture and retaining flanges 62 extending from either side of the aperture. The retaining flanges 62 may each include openings 66. The bottom end of the seat post 10 may fit within the aperture such that openings 68 of the seat post 10 align with the openings 66 of the retaining flanges 62. Bolts 64 may run through the aligned openings 66, 68, thereby securing the foot rest 28 to the bottom of the seat post 10.

To add additional stability, the present invention may further include support cables 30. Each of the support cables 30 may include a first end having a loop 32 and a second end having a loop 32. The loops 32 of the first end may align with openings 58 formed near the top end of the seat post 10. Bolts 54 may run through the loops 32 of the first end into the openings 58 of the seat post 10. Openings 56 may be formed through the foot rest 28. The loops 32 of the second end may align with openings 56 formed through the foot rest 28. Bolts 52 may run through the loops 32 of the second end into the openings 56 of the foot rest 28. The support cables 30 may thereby run from the top of the seat post 10 and secure to the foot rest 28 adding additional support to the tree stand.

The present invention may further include foot pegs 40. The foot pegs 40 may be attached to the seat post 10 above the foot rest 28, allowing the hunter to raise the height of the seat 26, while still having foot support. In certain embodiments, the pegs 40 may be pivotally secured to the seat post 10 and may be in a deployed position in which the pegs 40 are substantially perpendicular to the seat post 10 or a retracted position in which the pegs 40 are pivoted towards the seat post 10 and are substantially parallel to the seat post 10. The pegs 40 may be secured to the seat post 10 by a bracket 42. The bracket 42 may include openings 48 that align with openings 50 formed through the pegs 40. A pivot pin 44 may run through the aligned openings 48, 50, thereby pivotally attaching the pegs 40 to the seat post 10. Retaining nuts 46 may secure the pivot pins 44 within the aligned openings 48, 50.

In certain embodiments, the seat 26 may pivot upwards and downwards allowing the hunter to further adjust their position on the tree stand. In such embodiments, the present invention may include a seat mount 20. A pivoting bracket 18 may extend from a bottom of the seat mount 20. The pivoting bracket 18 may pivotally secure to the top end of the seat post 10, and may pivot about an axis perpendicular to the seat post 10. The seat mount 20 includes a fixed position and an adjustable position. The fixed position includes the seat mount and the seat post 10 fixed relative to each other and the adjustable position includes the seat mount 20 pivotal about the axis perpendicular to the seat post 10. An angle adjustment lever 24 may be used to lock and unlock the seat 26 in the fixed position.

In use, a hunter may strap the tree stand to the tree trunk 74 and tighten the strap 34 such that the tree brackets 70, 72 are firmly pressed against the tree trunk 74. The hunter may adjust the height the seat 26 relative to the foot rest 28 by pulling up on the height adjustment lever 22. The seat post 10 may be in the adjustable position and the hunter may either move the seat 26 up or down. The hunter may then release the height adjustment lever 22 and the seat 26 is fixed at the adjusted height. The hunter may then rotate the angle adjustment lever 24 and change the angle of the seat 26 relative to the seat post 10. The hunter may then rotate the angle adjustment lever 24 in the opposite direction, fixing the seat at the adjusted angle.

It should be understood, of course, that the foregoing relates to exemplary embodiments of the invention and that modifications may be made without departing from the spirit and scope of the invention as set forth in the following claims.

What is claimed is:

1. A tree stand comprising:
a seat post comprising a bottom end and a top end, a substantially hollow outer post, and an inner post disposed within the outer post;
a seat secured at the top end of the seat post;
a foot rest secured at the bottom end of the seat post;
at least one tree bracket protruding from a rear side of the seat post and comprising a first arm and a second arm operable to receive at least a portion of a tree trunk in between; and
a strap operable to secure the seat post to the tree trunk, wherein the seat post comprises a fixed position and an adjustable position, wherein the fixed position comprises the outer post and the inner post fixed relative to each other and the adjustable position comprises the outer post and the inner post slidably engaged and operable to adjust a height of the seat post, wherein the seat post is a gas spring comprising a piston disposed within a cylinder and a lever operable to engage a release button and transition the gas spring from the fixed position to the adjustable position substantially inaudibly.

2. (canceled)

3. The tree stand of claim 1, wherein seat post comprises seat post hooks operable to releasably retain strap hooks of the strap.

4. The tree strand of claim 1, wherein the strap comprises a ratchet operable to adjust a length of the strap.

5. The tree stand of claim 1, wherein the at least one tree bracket comprises a first tree bracket extending from the foot rest and a second tree bracket extending from the seat post near the top end.

6. The tree stand of claim 1, further comprising foot pegs secured to the seat post above the foot rest.

7. The tree stand of claim 6, wherein the foot pegs are pivotally secured to the seat post.

8. The tree stand of claim 1, further comprising a seat mount pivotally attached to the top end of the seat post, wherein the seat is attached to the seat mount.

9. The tree stand of claim 8, wherein the seat mount comprises a fixed position and an adjustable position, wherein the fixed position comprises the seat mount and the seat post fixed relative to each other and the adjustable position comprises the seat mount pivotal about an axis perpendicular to the seat post.

10. The tree stand of claim 1, further comprising support cables running from near a top end of the seat post to the foot rest.
